(19) United States
(12) Patent Application Publication
(10) Pub. No.: US 2010/0216620 A1
(43) Pub. Date: Aug. 26, 2010

(54) CENTRIFUGE

(75) Inventors: Ralf DE LA HAYE, Bielefeld (DE); Thomas HENKE, Borgholzhausen (DE); Andreas LEVERMANN, Lage (DE); Wolfgang AMRHEIN, Ottensheim (AT); Siegfried SILBER, Kirchschlag (AT); Herbert GRABNER, Linz (AT)

Correspondence Address: PATENT CENTRAL LLC;Stephan A. Pendorf, 1401 Hollywood Boulevard, Hollywood, FL, 33020, US

(73) Assignee: Hanning Elektro-Werke GmbH & Co. KG, Oerlinghausen (DE)

(21) Appl. No.: 12/710,562

(22) Filed: Feb. 23, 2010

(30) Foreign Application Priority Data
Feb. 23, 2009 (DE) 10 2009 009 958.1

(51) Int. Cl. B04B 9/02; B04B 9/10

(52) U.S. Cl. 494/8; 494/84

(57) ABSTRACT

The invention relates to a centrifuge, in particular a laboratory centrifuge, with a centrifuge rotor to hold material and with an electric motor, exhibiting a stator, a rotor that is associated with the stator and a fastening means for the localization of the electric motor at a stationary support and for a torque proof connection of the rotor with the centrifuge rotor, in which the centrifuge rotor features a recess on a face side that is facing the electric motor, in which the recess of the centrifuge rotor is designed such, that the electric motor can be at least partially positioned in said recess.

The invention relates to a centrifuge, in particular a laboratory centrifuge, with a centrifuge rotor to hold material and with an electric motor, exhibiting a stator, a rotor that is associated with the stator and a fastening means for the localization of the electric motor at a stationary support and for a torque proof connection of the rotor with the centrifuge rotor, in which the centrifuge rotor features a recess on a face side that is facing the electric motor.

DE 195 16 904 A1 discloses a laboratory centrifuge with a rotational symmetric centrifuge rotor, which features a recess on a face side that is facing the electric motor that serves as the drive for the laboratory centrifuge. The recess is arranged coaxially to an axis of rotation of the electric motor and the centrifuge rotor. The electric motor and the centrifuge rotor are connected by means of an elastic coupling that serves the decoupling of the electric motor and the centrifuge rotor in terms of vibrations. Concurrently the coupling transmits the motion of the electric motor to the centrifuge rotor. The centrifuge rotor is retained in the area of a shaft element that connects it with the coupling by means of a rotary bearing. By using a separate rotary bearing for the centrifuge rotor the forces acting on the centrifuge rotor during operation do not need to be supported by the electric motor. The arrangement of the elastic coupling and the rotary bearing between the electric motor and the centrifuge rotor is detrimental. It results in a large axial distance of centrifuge rotor and electric motor in the direction of the rotary axis and contradicts the customer's desire for a compact design, particularly a minimal overall height. Furthermore the introduction of an elastic coupling and a rotary bearing is disadvantageous from cost perspective.

The objective of the invention is to provide a centrifuge design that allows a cost efficient manufacturing, a minimized overall height and a low susceptibility for vibrations.

The objective is accomplished by the invention according to the characterizing portion of claim 1 thereby characterized, that the recess of the centrifuge rotor is designed such that the electric motor can be at least partially positioned in the recess.

The particular advantage of the invention consists in the arrangement of the electric motor in the recess resulting in a compact design with a minimized overall height as well as a reduced susceptibility for vibrations. Generally centrifuges are operated at high rotation speeds in order to separate solid respectively liquid constituents of the processed materials. During operation high centrifugal forces occur. The centrifugal forces act as shearing forces normal to the drive shaft and represent a bending moment onto the shaft. The magnitude of the bending moment is proportional to the centrifugal forces as well as the torsion arm length of the centrifugal forces with respect to the motor bearing. Since the torsion arm length is small through the at least partial positioning of the electric motor in the recess of the centrifuge rotor, the bending moment on the drive shaft as well as the reactive forces onto the motor bearing are reduced. Furthermore the amplitude of the occurring vibrations is low as a result of the compact design.

In a further embodiment according to the invention the recess in the centrifuge rotor is rotational symmetrical, e.g. in form of a cylinder or a truncated cone. A rotational symmetric recess if advantageous in terms of manufacturability if e.g. the centrifuge rotor is produced as an injection molded plastic part. In this case the recess does not need to be machined in a subsequent process step. By utilization of a truncated cone form or a cylindrical form undercuts and similar complications are avoided.

In another embodiment according to the invention the rotor and the stator are at least partially surrounded by a motor housing. This advantageous arrangement with the motor housing results in a compact and enclosed unit. In this configuration the electric motor is protected from damage by the motor housing.

In another embodiment according to the invention a drive side boundary area facing the centrifuge rotor and/or a middle section featuring the stator and the rotor and/or a support side boundary area of the electric motor opposite to the drive side boundary area are at least partially positioned in the recess. Thus an advantageous integration of the electric motor into the recess is achieved resulting in a further reduction of the vibration susceptibility of the centrifuge and a reduction of its overall height. Here the support side boundary area may feature a B-bearing plate.

In a further embodiment according to the invention the electric motor is chosen to be a synchronous motor and the rotor is chosen to be a permanent magnet rotor. By choosing a synchronous motor as the electric motor a high efficiency is achieved compared to motors based on other principles. The synchronous motor exhibits only small losses. These small losses result in only a minor heating of the drive and in a lower thermal loading of the materials in the centrifuge. The low thermal loading of the materials allows for an even higher degree of integration of the electric motor into the centrifuge rotor.

In another embodiment according to the invention the rotor may be integrated into the centrifuge rotor and is configured with a permanent magnet with integrated back iron. By integrating the rotor into the centrifuge rotor respectively by using the centrifuge rotor as the rotor of the electric engine and by omitting the use of iron a significant cost reduction for the centrifuge can be realized.

In another embodiment according to the invention the electric motor may be configured as an external rotor motor. Here the motor housing is connected torque proof to the centrifuge rotor in a drive side boundary area and connected to the rotor in the area of the middle section of the electric motor. Configuring an external rotor motor is particularly advantageous because the centrifuge rotor can be directly connected to the rotating motor housing. Due to the protected location of the electric motor in the recess of the centrifuge rotor an additional fixed housing surrounding the electric motor is unnecessary. In this case it is sufficient to surround the rotating components with a shared housing. Another advantage is the fact that an external rotor motor is slimmer in axial direction than an internal rotor motor with comparable performance specifications thus facilitating a compact design and a small overall height.

In a further embodiment according to the invention an at least partial divider can be introduced between the centrifuge rotor and the motor housing in which this divider can be designed from a thermally insulating material. By introducing a divider, particularly a thermally insulating divider, the thermal exposure of the material in the centrifuge rotor can be further reduced. Motor housing, divider and recess can be designed such that the divider is located in the recess of the centrifuge rotor. The divider can be adapted to the contour of the recess and/or to the geometry of the motor housing. Therefore the compact and vibration suppressing design of the centrifuge can be even realized when temperature sensitive materials that need to be protected from the heat generated by the electric motor are to be processes.

In another embodiment according to the invention the electric motor is in relation to the support suspended by a magnetic bearing. The magnetic bearing can be designed to be an active magnetic bearing that is controlled by a controller unit such that vibrations that occur during operation due to an unbalance are damped through electromagnetic stabilizing forces in the magnetic bearing. By using an active magnetic bearing it is possible to efficiently damp vibrations that occur during operation. Using a magnetic bearing that is an active magnetic bearing allows for the individual damping of the centrifuge depending on its load or the rotational speed of the centrifuge rotor. Since the magnetic bearing is a contactless bearing there is not mechanical wear. Also material ageing particularly occurring in elastomeric damping elements is reduced. The usable life of the centrifuge is thereby positively affected.

Further advantages of the invention are described in the dependent claims. Embodiments of the invention will be explained in more detail with the below listed illustrations and reference designators.

They show:

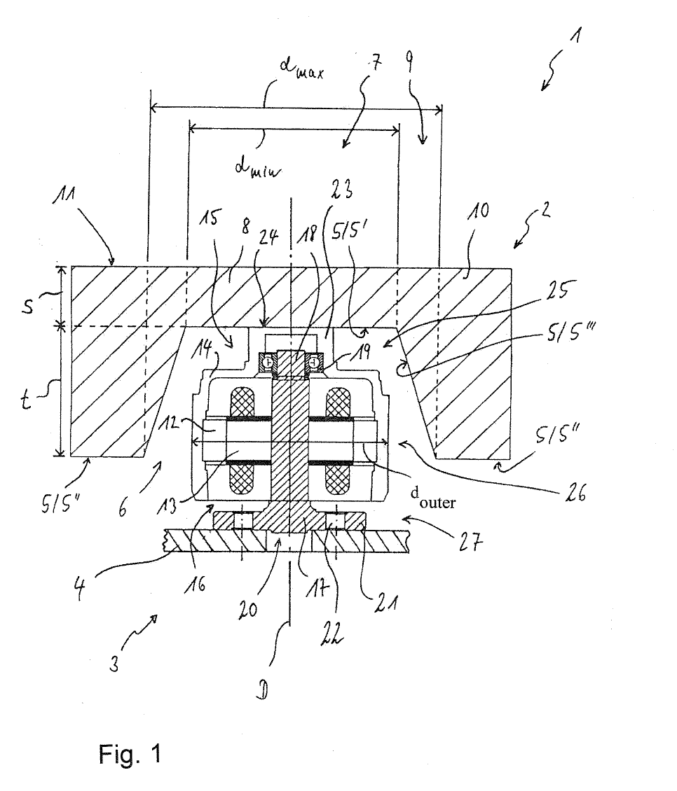

FIG. 1 a sectional representation of a first embodiment of a centrifuge according to the invention,

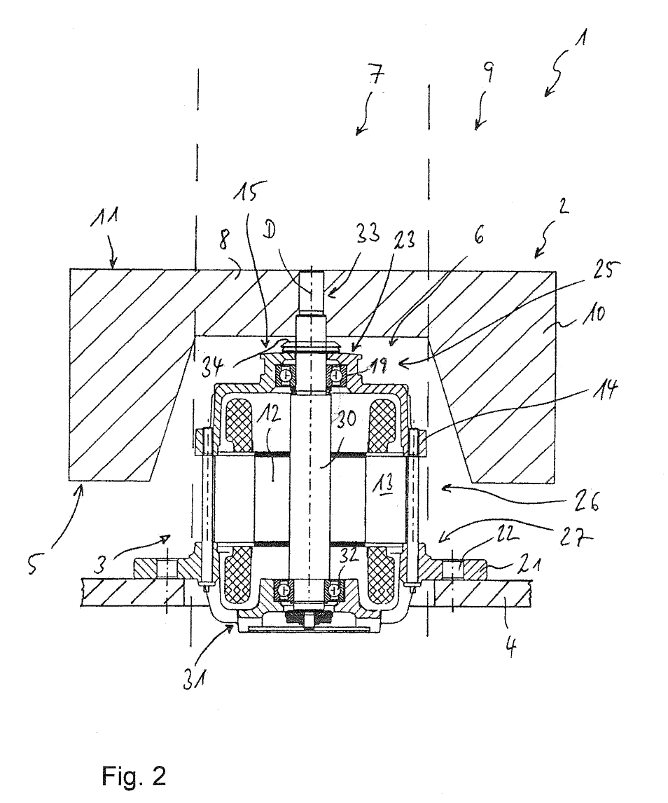

FIG. 2 a sectional representation of a second embodiment of a centrifuge according to the invention,

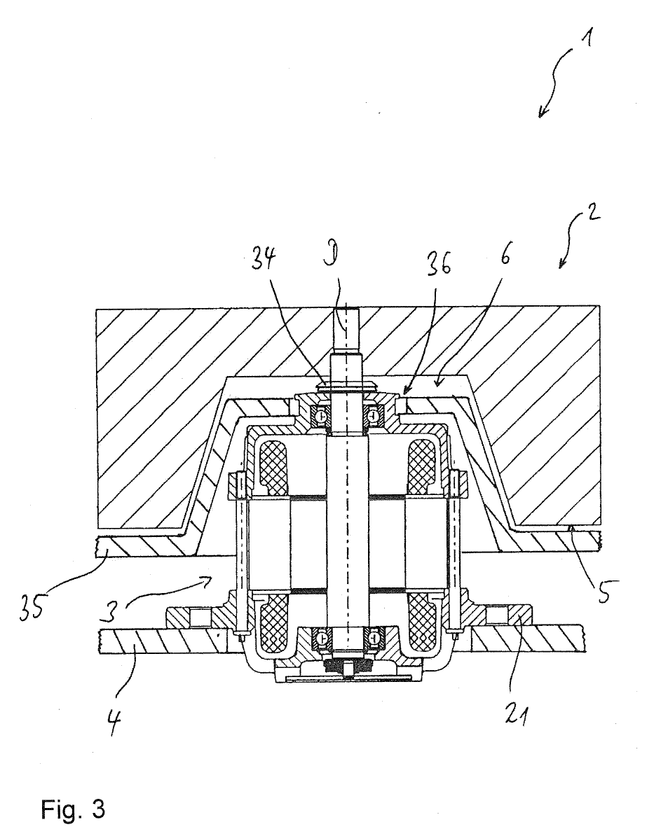

FIG. 3 a sectional representation of a centrifuge according to FIG. 2 with a divider between a centrifuge rotor and a motor housing according to the invention,

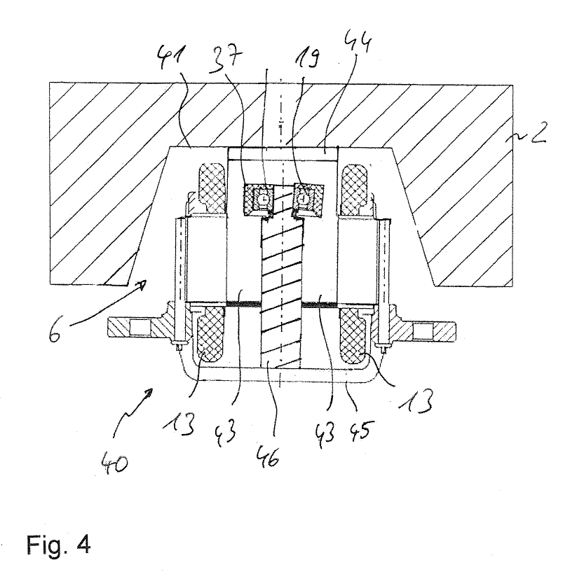

FIG. 4 a sectional representation of a centrifuge rotor according to a third embodiment of a centrifuge according to the invention, in which the centrifuge rotor is driven by a internal rotor motor, in which a rotor of the internal rotor motor is attached to the centrifuge rotor through a mounting plate and

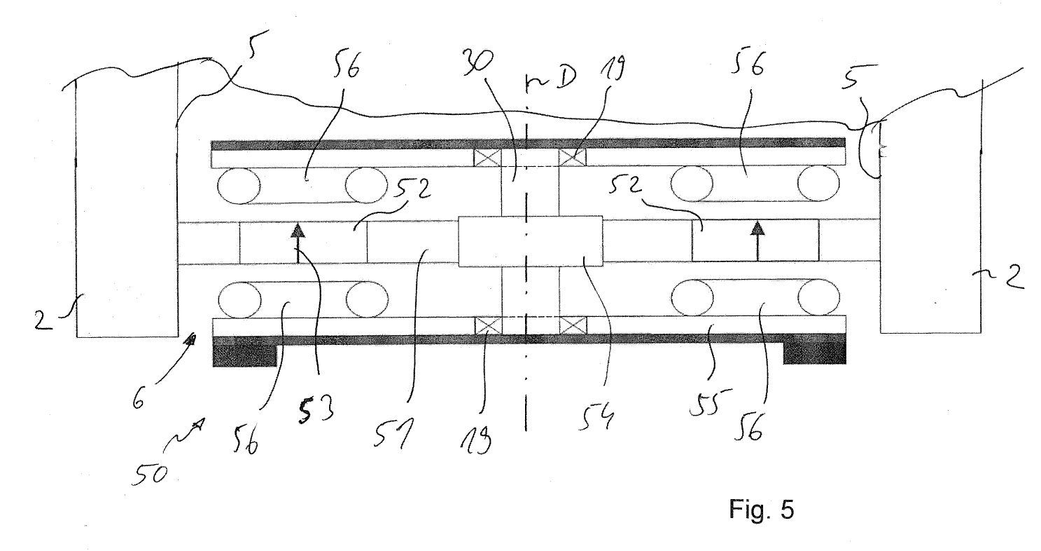

FIG. 5 a partial sectional representation of a centrifuge according to a further embodiment according to the invention in the area of a recess of the centrifuge.

A laboratory centrifuge 1 according to FIG. 1 is usually used to separate different materials of a sample. The laboratory centrifuge 1 consists basically of a centrifuge rotor 2 and an electric motor 3, which is mounted to a stationary support 4, for example a centrifuge housing. Centrifuge rotor 2 and electric motor 3 feature a shared rotation axis D.

The centrifuge rotor 2 is designed as a rotational symmetric body and coaxial with respect to the rotation axis D of the centrifuge 1. It features a recess 6 on a face side 5 which is facing the electric motor 3. The recess 6 is preferably designed as a truncated cone and also symmetrical with respect to the rotation axis D of the centrifuge 1. In an inner segment 7 with respect to the rotation axis D which is in close proximity to the axis, the centrifuge rotor 2 features a connecting segment 8 for the attachment of the centrifuge rotor 2 to the electric motor 3. In an outer segment 9, further away from the axis, a ring segment 10 is adjacent to the connecting segment 8. The primary function of this ring segment 10 is to hold the material samples. In the area of the connecting segment 8 the centrifuge rotor 2 features an axial thickness s. The circular segment 5′ of face side 5 which is facing the electric motor 3 is assigned to an inner segment 7. It is flat and planar. Also the outer annular band segment 5″ of the face side 5 on the rotor side and a second face side 11 that is opposite to the face side 5 of the centrifuge rotor 2 are flat and planar. The second face side 11 as well as the circular segment 5′ and the annular band segment 5″ of the face side 5 are normal to the rotation axis D.

The recess 6 features a depth t, which is measured from the level of the annular band segment 5″ of the face side 5 in axial direction to the level of the circular segment 5′ of the face side 5. In the area of the circular segment 5′ the recess 6 in the form of a truncated cone features a minimum diameter dₘᵢₙ. The recess 6 exhibits its maximum diameter dₘₐₓ in the area of the annular band segment 5″. The circular segment 5′ and the annular band segment 5″ of the face side 5 are connected by a mantle segment 5′″ of the face side 5. The circular segment 5′, the annular band segment 5″ and the mantle segment 5″′ of the face side 5 are arranged coaxial to the rotation axis D and form together the face side 5 on the rotor side.

The electric motor 3 basically consists of a rotor 12, a stator 13 corresponding to the rotor 12, as well as a motor housing 14. The electric motor 3 is for example an external rotor motor such that the rotor 12 radially surrounds the stator 13 which is stationary with respect to the support 4. The rotor 12 is connected torque proof with the motor housing 14 and is surrounded by it radially as well as by a face side 15 of the electric motor 3 that is facing the centrifuge rotor 2. In this embodiment the motor housing 14 is designed in form of a bell and features an opening 16 on a side opposite to the face side 15.

The stator 13 exhibits a bolt 17 coaxially to the rotation axis D in which the motor housing 14 is supported by a ball bearing 19 on the bolt's 17 first end section 18 that is facing the centrifuge rotor 2. On its second end section 20 opposite to the first end section 18, the bolt 17 features a mounting section 21 that radially projects outwards from said bolt 17. Holes 22 are arranged in the mounting section 21 for the attachment of the bolt 17 to the support 4 by means of fasteners that are not shown here, for example screws, rivets and the like. Alternatively the stationary components of the electric motor 3 and the support 4 can be bonded by an adhesive.

The motor housing 14, the rotor 12, the stator 13, the ball bearing 19, the opening 16, the bolt 17 and the mounting section 21 are arranged coaxial to each other and symmetric to the rotation axis D of the centrifuge 1. The opening 16 of the motor housing 14 is large enough to bring the rotor 12, the stator 13 and the ball bearing 19 through said opening 16 into the motor housing 14.

In the area of the face side 15 of the electric motor 3 that is facing the centrifuge rotor 2, the motor housing 14 is designed as an A-bearing plate 23 for the reception of the ball bearing 19. The motor housing 14 features in the area of the A-bearing plate 23 a connecting section 24 for the torque proof connection of the rotor 12 with the centrifuge rotor 2. The connecting section 24 is radially flat and planar such that it can easily connect with the also flat and planar circular segment 5′ on the face side 5, for example by screwing, bonding or the like. The connecting section 24 of the motor housing 14 is arranged symmetrical in reference to the rotation axis D.

In axial direction the electric motor 3 is divided into three parts. The A-bearing plate 23 with the connecting section 24 is arranged in a drive side boundary area 25 that is facing the centrifuge rotor 2. Adjacent to the drive side boundary area 25 a middle section 26 of the electric motor 3 follows that includes the stator 13 and the rotor 12. In the area of the middle section 26 the rotor 12 is connected torque proof to the motor housing 14. A support side boundary area 27 of the electric motor 3 follows adjacent to the middle section 26 on the opposite side of the drive side boundary area 25. In the area of the support side boundary area 27 the mounting section 21 of the bolt 17 is connected to the support 4 by means of fasteners that are not shown here.

The electric motor 3 that is configured as an external rotor motor is arranged internally to the centrifuge 1 like a pendulum only supported by the ball bearing 19 in the area of the A-bearing plate 23. A second bearing respectively a B-bearing plate is not necessary for the chosen motor configuration (external rotor motor). By omitting the second bearing location the electric motor 3 is very compact in axial direction such that the drive side boundary area 25 as well as part of the middle section 26 of the electric motor 3 can be located in the recess 6. The outer diameter dₒᵤₜₑᵣ of the motor housing 14 is dimensioned such that the electric motor 3 and the connecting segment 8 of the centrifuge rotor 2 can be located in an inner segment 7 of the centrifuge 1 with respect to the rotation axis D which is in close proximity to the axis D. Only the ring segment 10 of the centrifuge rotor 2 which surrounds the connecting segment 8 of the centrifuge rotor 2 as well as parts of the motor housing 14 radially is assigned to the outer segment of the centrifuge 1. The low overall height achieved thereby contributes to the fact that bending moments that the electric motor 3 needs to absorb and that result from an unbalance are small. This results in a reduced susceptibility to vibration and smaller vibration amplitudes of the centrifuge 1.

The spatial integration of the electric motor 3 and the centrifuge rotor 2 will be promoted even further by using a synchronous motor as the electric motor 3. The efficiency of a synchronous motor is very high compared to the efficiency of motors based on other design principles, such that only minor losses occur and the electric motor 3 heats up only marginally. Based on the marginal heating of the electric motor 3 the thermal loading of the centrifuge 1 and particularly of the material samples in the centrifuge rotor 2 is marginal. For this reason a thermal insulation between the centrifuge rotor 2 and the electric motor 3 is not necessary for this embodiment according to the invention.

In an alternative embodiment according to FIG. 2 according to the invention an electric motor 3 is used which is configured as an internal rotor motor.

The electric motor 3 features in the area of a drive side boundary area 25 an A-bearing plate 23 with a ball bearing 19 for the bearing of the rotor 12 which is connected torque proof on a shaft 30. Further the electric motor 3 features in the area of the support side boundary area 27 a B-bearing plate 31 with a second ball bearing 32 for the torque proof support of the shaft 30. The electric motor 3 exhibits mounting sections 21 in the middle section 26 which is located between the drive side boundary area 25 and the support side boundary area 27 to mount the electric motor 3 on a support 4 that radially projects outwards from the motor housing 14.

Identical components and component functions of the described embodiments according to the invention are labeled with identical reference designators. The motor housing 14 which is stationary with reference to the support 4 is firmly attached to the stator 13. The stator 13 which is connected torque proof to the shaft 30 interacts with the rotor 12 which is arranged radially inwards with respect to the stator 13. The shaft 30 exhibits a drive side end section 33 which protrudes the motor housing 14 and is connected torque proof to the centrifuge rotor 2. The shaft 30, the rotor 12, the stator 13, the motor housing 14, the drive side ball bearing 19, the support side second ball bearing 23 as well as the mounting sections 21 are coaxial and symmetrical with reference to the rotation axis D of the centrifuge 1. Between the drive side face side 15 of the motor housing 14 and the circular segment 5′ of the motor side face side 15 of the centrifuge rotor 2 disk shaped gaskets 34 are provided to seal the electric motor 3 against moisture intruding from the A-bearing plate 23 in axial direction into the electric motor 3.

In the following embodiment according to the invention the electric motor 3 is also configured as a synchronous motor. The rotor 12 exhibits a permanent magnet. The drive side boundary area 25 as well as a part of the middle section 26 of the electric motor 3 are located in the recess 6 of the centrifuge rotor 2. Since as a consequence of the electromagnetic actor principle a B-bearing plate 31 is needed on the support side, the electric motor 3 according to the second embodiment is longer than the one in the first embodiment.

In a third embodiment according to FIG. 3 according to the invention a divider 35, which is shaped like a truncated cone matching the recess 6, is partially arranged between the centrifuge rotor 2 and the electric motor 3. Only in the area of the A-bearing plate 23 the divider 35 features a recess 36.The divider 35 is stationary and may be mounted to the support 4 for instance. The divider 35 can be designed to be thermally insulating. It protects the centrifuge rotor 2 and particularly the material samples held in the ring segment 10 of the centrifuge rotor 2 from the heat generated by the electric motor 3. Utilizing a thermally insulating divider 35 is particularly advantageous when thermally sensitive material samples are centrifuged. Also an energetically less favorable electric motor 3, e.g. an asynchronous motor, may be used for the centrifuge 1.

In a further embodiment according to FIG. 4 according to the invention the electric motor 40 is configured as an internal rotor motor in which a rotor 43 is firmly mounted to a bottom 41 of the centrifuge rotor 2 by means of a mounting plate 44. The rotor 43 is suspended by means of a spring damper element 37 and the radially adjacent ball bearing 19 on a stationary shaft 46. The spring damper element 37 may for instance consist of a resilient elastomeric material which is molded around the ball bearing 19. The shaft 46 extends coaxial to the rotation axis D and is mounted to a stationary support 45. As an advantageous configuration for this embodiment a mechanical bearing 19, 37 is chosen which can alternatively be located on the opposite side of the rotor 43. As a further advantage an A-bearing plate is not necessary such that the electric motor 40 respectively in particular the rotor 43 and the stator 13 can be positioned further into the recess 6. Thus the electric motor 40 is configured to be open with the side facing the bottom 41.

In a further embodiment according to FIG. 5 according to the invention the electric motor 50 is configured as a disk shaped motor, e.g. a transverse flux machine or as a shrunk-on-disk motor in which the motor based on its shallow design is mainly located within the recess 6 of the centrifuge rotor 2. A central disk 51 exhibits permanent magnets 52 with a direction of their polarity in parallel to the rotation axis D, see arrow 53. The radial outer edge of the central disk 51 is connected torque proof with the face side 5 of the centrifuge rotor 2. In a center area the central disk 51 is suspended by a magnetic bearing 54 on the shaft 30. While the central disk 51 serves as rotor of the shrunk-on-disk motor 50, a stator 55 is located opposite to the flat sides of the central disk 51 with stationary coils for the corresponding permanent magnets 52. The stator 55 is suspended on the shaft 30 by means of a ball bearing (mechanical bearing). Because of the shallow design of the shrunk-on-disk motor 50 it fits into the recess 6 almost completely. Thus the centrifuge 2 is particularly space-saving.

The electric motors described above may feature magnetic bearings 54 respectively magnetic actuators which may be controlled by a controller unit that is not shown here such that unwanted forces or vibrations acting upon the centrifuge rotor 2 can be compensated or counterbalanced. Unwanted vibrations may be vibrations cause by unbalance in which the rotation axis is not intersecting with the center of mass of the centrifuge rotor 2 (static unbalance). The vibrations caused by the unbalance may in addition cause unwanted wobbling of the centrifuge rotor 2 (dynamic unbalance), which needs to be prevented. Magnetic actuators 54 are preferably electrical coils, which are arranged in circumferential direction around the rotating axis D.

In a further embodiment according the invention that is not illustrated here the ball and roller bearing may be replaced by a friction bearing and/or a magnetic bearing to suspend the rotating components of the centrifuge 1. It is also possible to use different bearings in the centrifuge 1. The shaft 30 for instance may be suspended by a friction bearing in the first end section and by a ball and roller bearing in the second end section.

When choosing a magnetic bearing it may be a passive magnetic bearing and/or an active magnetic bearing. In the case of a passive magnetic bearing the rotating component will be suspended by two magnets of equal polarity that produce repelling magnetic force. The magnetic forces in this case will be defined by the choice of magnets and the width of the air gap between the repelling magnets only. In the case of an active magnetic bearing a control unit may additionally make use of information induced by the occurring vibrations and modify the damping and or the stiffness of the drive system such that particularly in the range of the resonant frequency no excessive bearing forces occur.

In an alternative embodiment according the invention that is not illustrated here the electric motor is configured as a bearingless electric motor.

The centrifuge rotor 2 is preferably closed in its outer axial area. Alternatively it can be discontinuous in its outer axial area such that individual arms in which the material (samples) can be introduced extend radially.

Reference Numeral List

| No. | Description |
|---|---|
| 1 | Centrifuge |
| 2 | Centrifuge motor |
| 3 | Electric motor |
| 4 | Support |
| 5 | Face side (2) |
| 5′ | Circular segment (5) |
| 5″ | Annular band segment (5) |
| 5′″ | Mantle segment (5) |
| 6 | Recess |
| 7 | Inner segment |
| 8 | Connecting segment |
| 9 | Outer segment |
| 10 | Ring segment |
| 11 | Second face side |
| 12 | Rotor |
| 13 | Stator |
| 14 | Motor housing |
| 15 | Face sides (3) |
| 16 | Opening (14) |
| 17 | Bolt |
| 18 | First end section (17) |
| 19 | Ball bearing |
| 20 | Second end section (17) |
| 21 | Mounting section |
| 22 | Holes |
| 23 | A-bearing plate |
| 24 | Connecting section |
| 25 | drive side boundary area |
| 26 | Middle section |
| 27 | support side boundary area |
| 30 | Shaft |
| 31 | B-bearing plate |
| 32 | Second ball bearing |
| 33 | Drive side end section |
| 34 | Gaskets |
| 35 | Divider |
| 36 | Recess |
| 37 | Spring damper elements |
| 40 | Electric motor |
| 41 | bottom |
| 43 | Rotor |
| 44 | Mounting plate |
| 45 | Support |
| 46 | Shaft |
| 50 | Electric motor |
| 51 | Central disk |
| 52 | Permanent magnet |
| 53 | Polarity direction |
| 54 | Magnetic bearing |
| 55 | Stator |
| 56 | Coils |
| dₘᵢₙ | Minimum diameter |
| dₘₐₓ | Maximum diameter |
| dₒᵤₜₑᵣ | Outer diameter |
| t | Depth (6) |
| s | Thickness (2) |
| D | Axis of rotation |

1. A centrifuge, in particular a laboratory centrifuge, with a centrifuge rotor to hold material and with an electric motor, exhibiting a stator, a rotor that is associated with the stator and a fastening means for the localization of the electric motor at a stationary support and for a torque proof connection of the rotor with the centrifuge rotor, in which the centrifuge rotor features a recess on a face side (5) that is facing the electric motor, wherein that the recess (6) of the centrifuge rotor (2) is designed such, that the electric motor (3) can be at least partially positioned in the recess (6).

2. The centrifuge according to claim 1, wherein that the recess (6) of the centrifuge rotor (2) is of rotational symmetric shape.

3. The centrifuge according to claim 1, wherein that the recess (6) of the centrifuge rotor (2) is designed in form of a truncated cone or a cylinder.

4. The centrifuge according to claim 1, wherein that the stator (13) and the rotor (12) are at least partially surrounded by a motor housing (14).

5. The centrifuge according to claim 1, wherein that a drive side boundary area (25) of the electric motor (3), which is facing the centrifuge rotor (2), is at least partially positioned in the recess (6).

6. The centrifuge according to claim 1, wherein that a middle section (26) of the electric motor (3) which features the stator (11) and the rotor (12) is at least partially positioned in the recess (6).

7. The centrifuge according to claim 1, wherein that a support side boundary area (27) of the electric motor (3) which is located opposite to the drive side boundary area (25) is at least partially positioned in the recess (6).

8. The centrifuge according to claim 1, wherein that the electric motor (3) is a permanently excited synchronous motor with the rotor (12) being a permanent magnet rotor.

9. The centrifuge according to claim 8, wherein that the rotor (12) is configured with a permanent magnet with integrated back iron.

10. The centrifuge according to claim 1, wherein that the rotor (12) is located inside the centrifuge rotor (2).

11. The centrifuge according to claim 1, wherein that the electric motor (3) is configured as an external rotor motor in which the motor housing (14) is connected torque proof with the centrifuge rotor (2) as well as it is connected torque proof with the rotor (12).

12. The centrifuge according to claim 11, wherein that the motor housing (14) in the drive side boundary area (25) is connected torque proof to the centrifuge rotor (2).

13. The centrifuge according to claim 11, wherein that the motor housing in the area of the middle section (26) is connected torque proof to the rotor (12).

14. The centrifuge according to claim 11, wherein that the motor housing (14) is designed in form of a bell and features an opening (16) which is located on a side of the motor housing (14) that is facing away from the drive side boundary area (25).

15. The centrifuge according to claim 1, wherein that the electric motor (3) is configured as an internal rotor motor in which the rotor (12) is connected torque proof with a shaft (30) and in which the shaft (30) is connected torque proof to the centrifuge rotor (2) with a drive end section (33) of said shaft (30) that is facing the centrifuge rotor (2).

16. The centrifuge according to claim 1, wherein that between the centrifuge rotor (2) and the motor housing (14) an at least partial divider (35) is introduced.

17. The centrifuge according to claim 16, wherein that the divider (35) is constructed as a thermally insulating divider (35).

18. The centrifuge according to claim 1, wherein that the centrifuge rotor (2) is configured coaxially with reference to the stator (13) and/or to the rotor (12) and/or to the motor housing (14).

19. The centrifuge according to claim 1, wherein that the centrifuge rotor (2) holds the materials to be processed in an outer segment (9), that is further away from the axis, with respect to the rotation axis (D), and is configured to be closed or discontinuous or open in its outer segment (9) in circumferential direction, and that the centrifuge rotor (2) is connected torque proof in an inner segment (7), which is in close proximity to the axis with respect to the rotation axis (D), to a rotor (12) of the electric motor (3).

20. The centrifuge according to claim 1, wherein that the recess (6) features a depth (t) that is larger or equal to the axial thickness (s) of the centrifuge rotor (2) in the connecting segment (8).

21. The centrifuge according to claim 1, wherein that the face side (5) of the centrifuge rotor (2) facing the electric motor (3) in its connecting segment (8) is at least partially planar.

22. The centrifuge according to claim 1, wherein that an A-bearing plate (23) is configured in the drive side boundary area (25).

23. The centrifuge according to claim 1, wherein that a B-bearing plate (31) is configured in the carrier side boundary area (27).

24. The centrifuge according to claim 1, wherein that the electric motor (3) is suspended by a magnetic bearing and/or a ball and roller bearing and/or a friction bearing.

25. The centrifuge according to claim 1, wherein that the electric motor is configured as a disk shaped motor (50) which is mainly located inside the recess (6) of the centrifuge rotor (2).

26. The centrifuge according to one claim 1, wherein that the electric motor (3) is with reference to the support (4) elastically suspended by spring damper elements (37).

27. The centrifuge according to one claim 1, wherein that the rotor (12) of the electric motor (3) is suspended with at least one hearing (19) at the support, in which at least one magnetic actuator which is controlled by a controller unit such that unwanted forces or vibrations acting upon the centrifuge rotor (2) can be counteracted and/or that unwanted forces respectively unwanted vibrations of the centrifuge rotor (2) are reduced and/or are partially compensated with reference to each other.
